(19) United States
(12) Patent Application Publication
(10) Pub. No.: US 2025/0167648 A1
(43) Pub. Date: May 22, 2025

(54) SYSTEMS AND METHODS FOR ROTOR REFURBISHMENT

(71) Applicant: Integrated Power Services LLC, Greenville, SC (US)

(72) Inventors: Shahram Negari, Irvine, CA (US); Jeremy Culmer, Cleveland, OH (US); Jeffrey Kenney, Cleveland, OH (US)

(21) Appl. No.: 18/957,415

(22) Filed: Nov. 22, 2024

Related U.S. Application Data
(60) Provisional application No. 63/602,196, filed on Nov. 22, 2023.

(51) Int. Cl. H02K 15/00; H02K 1/02; H02K 15/02; H02K 15/04; H02K 19/02

(52) U.S. Cl. CPC H02K 15/50; H02K 1/02; H02K 15/02; H02K 15/0414; H02K 19/02; H02K 2213/12

(57) ABSTRACT

Techniques described include refurbishing a rotor of an electric machine such as an electric generator by assembling replacement modular bars in lieu of certain non-modular bars, such as amortisseur bars. The replacement modular bars are provided in different threaded sections based on their location on the rotor, with the sections then threaded onto each other.

### CLAIM OF PRIORITY

This application claims the benefit of priority under 35 U.S.C. § 119 (e) to U.S. Provisional Patent Application Ser. No. 63/602,196, filed on Nov. 22, 2023, which is incorporated by reference herein in its entirety.

### BACKGROUND

Certain electric machinery, such as generators and motors, include rotors that rotatably convert mechanical motion into electric power, or vice versa. Rotors include windings that conductively transfer electricity as the rotor interacts magnetically with a magnetic field produced by a stator. In a generator, mechanical rotation of the rotor will then generate electricity transmitted via the windings, for example, for electric power production. It would be beneficial to improve on techniques for refurbishment of rotors.

### BRIEF SUMMARY

The techniques being described herein include a new process for refurbishing synchronous rotors (e.g., disposed in large electric power generators) by replacing damaged or cracked amortisseur winding copper bars. In certain examples, the new process includes replacing rotor amortisseur bars with modular, segmented copper bars that can be assembled and screwed together piece-by-piece. The segmented bars are designed to fit into the small space between the main winding and rotor core without having to remove the main coils. This eliminates the need to rewind the main coils, which can be time and cost intensive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a rotor of the subject matter, in accordance with one embodiment.

FIG. 1B illustrates a cracked amortisseur bar of the rotor of FIG. 1A, in accordance with one embodiment.

FIG. 2A is a perspective view of a segmented copper bar, in accordance with one embodiment.

FIG. 2B is a sectional view of a segmented copper bar, in accordance with one embodiment.

FIG. 3A illustrates further details of a crack found just past a rotor core slot of the rotor of FIG. 1, in accordance with one embodiment.

FIG. 3B illustrates certain welds used to repair portions of the rotor of FIG. 1A, in accordance with one embodiment.

FIG. 4 illustrates the rotor of FIG. 1A after removal, in accordance with one embodiment.

FIG. 5A illustrates an inner band of the rotor of FIG. 1A, in accordance with one embodiment.

FIG. 5B illustrates the inner band of FIG. 5A during removal to allow for replacement of certain of the bars, in accordance with one embodiment.

FIG. 5C illustrates further details of the inner band of FIG. 5A during removal to allow for replacement of certain of the bars, in accordance with one embodiment.

FIG. 5D illustrates a section of the rotor of FIG. 1A with the inner band of FIG. 5A completely removed, in accordance with one embodiment.

FIG. 6 illustrates aspects of a milling operation, in accordance with one embodiment.

FIG. 7 illustrates amortisseur bars that have been removed, in accordance with one embodiment.

FIG. 8 illustrates an abrasive bits, in accordance with one embodiment.

FIG. 9 illustrates a steam cleaning station, in accordance with one embodiment.

FIG. 10 illustrates a plurality of segmented bars, in accordance with one embodiment.

FIG. 11 illustrates metal end fittings welded to end plates, in accordance with one embodiment.

FIG. 12 illustrates three end segments inserted into respective end fittings, in accordance with one embodiment.

FIG. 13 illustrates three end segments inserted into respective end fittings and then welded, in accordance with one embodiment.

FIG. 14A is a frontal perspective view of the rotor of FIG. 1A when placed inside an oven, in accordance with one embodiment.

FIG. 14B is a rear perspective view of the rotor of FIG. 1A when placed inside an oven, in accordance with one embodiment.

FIG. 15 illustrates the use of dye penetrant for testing of silver solder connections for a portion of the rotor of FIG. 1A, in accordance with one embodiment.

FIG. 16 shows the rotor of FIG. 1A being connected to electrical test machinery, in accordance with one embodiment.

FIG. 17A illustrates a perspective view of a replacement of a band into the rotor of FIG. 1A, in accordance with one embodiment.

FIG. 17B illustrates a perspective view of a replacement of a band into the rotor of FIG. 1A by workers, in accordance with one embodiment.

FIG. 17C illustrates a perspective view of a mew band inserted into the rotor of FIG. 1A, in accordance with one embodiment.

FIG. 18 illustrates a dip station used to rotor dip the rotor of FIG. 1A, in accordance with one embodiment.

FIG. 19A illustrates a front perspective view of a roll dip varnish cure station having the rotor of FIG. 1A, in accordance with one embodiment.

FIG. 19B illustrates a rear perspective view of a roll dip varnish cure station having the rotor of FIG. 1A, in accordance with one embodiment.

FIG. 20A illustrates the rotor of FIG. 1A disposed in a balancing equipment, in accordance with one embodiment.

FIG. 20B illustrates further details of the rotor of FIG. 1A disposed in the balancing equipment of FIG. 20A, in accordance with one embodiment.

FIG. 21A illustrates a side view of the rotor of FIG. 1A after the application of paint, in accordance with one embodiment.

FIG. 21B illustrates another side view of the rotor of FIG. 1A after the application of paint, in accordance with one embodiment.

FIG. 22 is a flowchart of a process for refurbishing the rotor of FIG. 1A, in accordance with one embodiment.

### DETAILED DESCRIPTION

The modular bars comprise a plurality of short, threaded copper segments. In certain embodiments, various segmented bars are used. For example, one embodiment uses four types of segments: long segments comprising the majority of the bar length; short segments; right end segments; and left end segments. The long segments have wrench flats to facilitate assembly using wrenches.

The existing amortisseur bars are first sliced into removable segments within the rotor slots using a portable milling machine. The segmented bars are then extracted, and the bar holes cleaned. New modular bars are assembled by inserting the short and long segments into the cleaned holes. The end segments are inserted and silver soldered to steel end plates welded within the rotor core openings. After baking and electrical testing, the rotor is reassembled with a new band and protective coatings.

By employing segmented bars that can be installed without removing the main coils, the present invention enables faster and more cost-effective replacement of amortisseur windings compared to conventional rewinding techniques. The modular design also provides flexibility and simplicity compared to prior unitary bar designs.

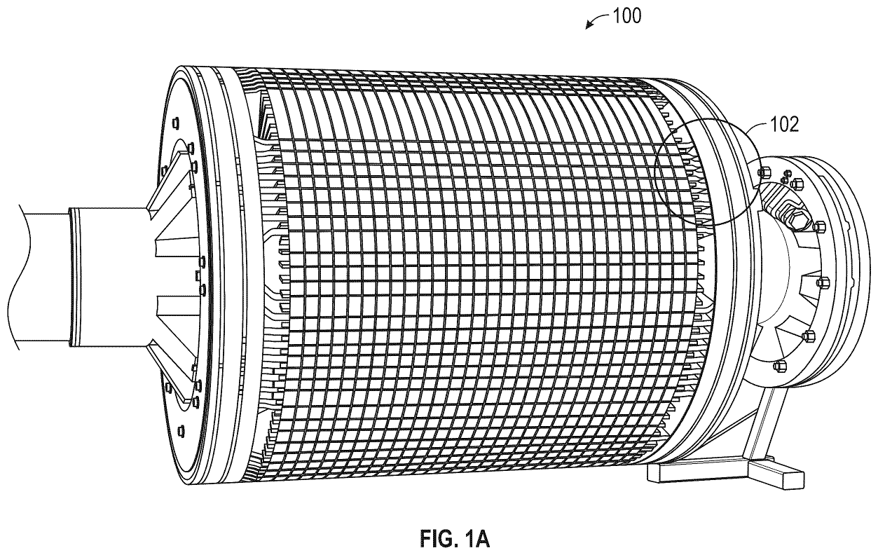

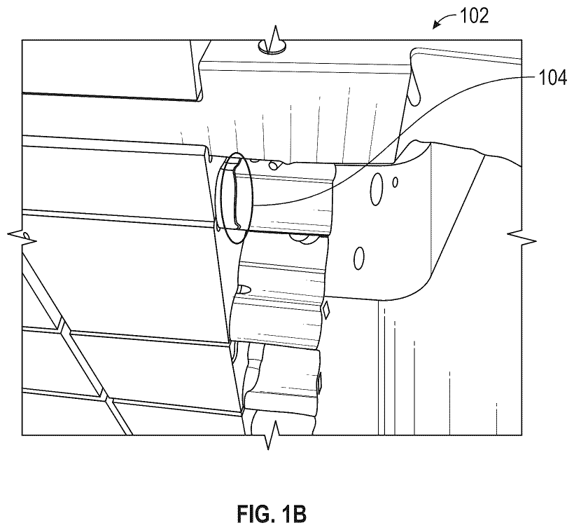

FIG. 1A illustrates a large rotor 100 (e.g., synchronous rotor) equipped with amortisseur windings, with a section 102 of the amortisseur or damper windings shown. It is to be noted that rotor 100 is used to produce electricity by being disposed inside of a stator assembly (not shown) and rotatably turned, for example, via a turbine system (e.g., gas turbine, steam turbine, water turbine). The amortisseur windings often face challenges in maintenance, especially when copper bars of the amortisseur are damaged or cracked. Since the damper winding is physically confined inside a main pole winding, the conventional repair technique typically demands the removal and replacement of the main coils, making the process time-intensive and financially burdensome.

FIG. 1B illustrates further details of the large synchronous rotor 100 of FIG. 1A, with the portion 102 of the large synchronous rotor 100 showing a crack 104 on an amortisseur winding. To fix the crack 104, field windings would be sacrificed and rebuilt, as access to amortisseur winding bars requires removal of field winding. This replacement of field windings can be very expensive. The larger the rotor 100, the larger the time for removal and the corresponding expense. In certain cases, lead time is between one and half to two years to procure material and to refurbish the rotor 100. Operators of rotors such as the rotor 100 have used the field winding replacement approach for years and problem persisted. Accordingly, the field winding replacement approach can considered a low quality, high risk approach.

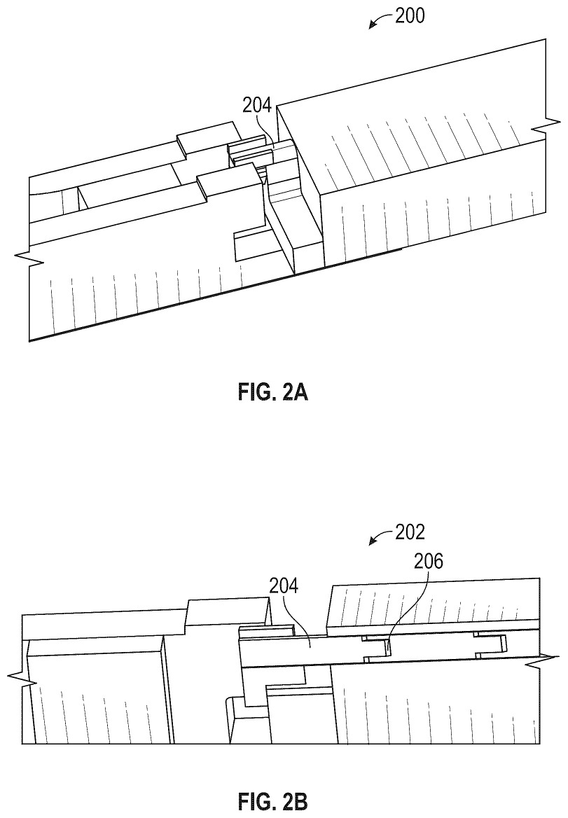

FIGS. 2A and 2B show the techniques described herein used to resolve the problem, e.g., cracks 104 in certain amortisseur bars, via the use of segmented metal (e.g., copper) bars 200, 202. The new techniques eliminates the need for main coil removal and subsequently, rewinding. These innovative techniques employs segmented copper bars 200, 202 shown in perspective in FIG. 2A and as a cross-sectional view in FIG. 2B which are assembled and screwed together in a modular fashion. More specifically, FIG. 2A shows the segmented copper bar 200 having a rear section 204 while FIG. 2B shows both the rear section 204 and a front threaded section 206 designed to be threaded into the rear section 204. These segments 200, 202 can be inserted into the rotor slots and tightened together sequentially, as the segments 200, 202 are designed to fit the small space available between the main winding and the rotor core. Therefore, any cracked amortisseur bars can be replaced piece-by-piece, preserving the integrity and position of the main coils.

Some advantages of the techniques described include:
Complete replacement of amortisseur bars.
No need for sacrificing and rewinding the field winding.
High quality complete repair.
The entire repair and re-caging operation can be done in 3-4 months.
Modularity of the concept of segmented bars offers increased flexibility and operational efficiency.
Since the field windings are kept intact and only amortisseur winding is rebarred, the replacement time and cost is a fraction compared to other techniques.

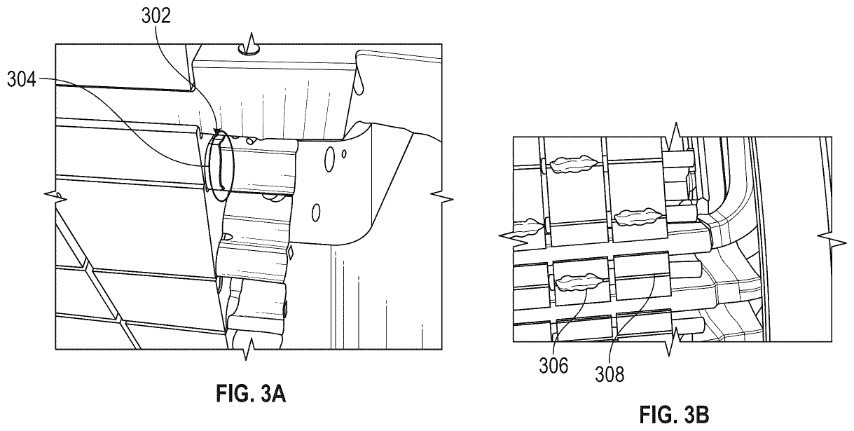

FIG. 3A illustrates further details of a crack 302 found just past a rotor core slot 304 of the rotor 100. A rotor core slot 304 may extend across the rotor 100 end-to-end, and have an amortisseur bar disposed inside of the slot 304. By way of example only and not as a limitation, a current amortisseur bar design disposed in the rotor 100 can include:
A 16 mm diameter bar approximately 68 inches long
104 total amortisseur bars
Material for each amortisseur bar is C110 copper alloy
Bars are insulated-most likely to secure them in the rotor holes
Bars are silver soldered on both ends to steel end plates
The example rotor shown in FIG. 3B was previously repaired for loose bars with welds 306 at lamination grooves 308 that were swedged into the bar

Each bar will then be replaced with multiple segmented bars (e.g., bars 200, 202), as further described below.

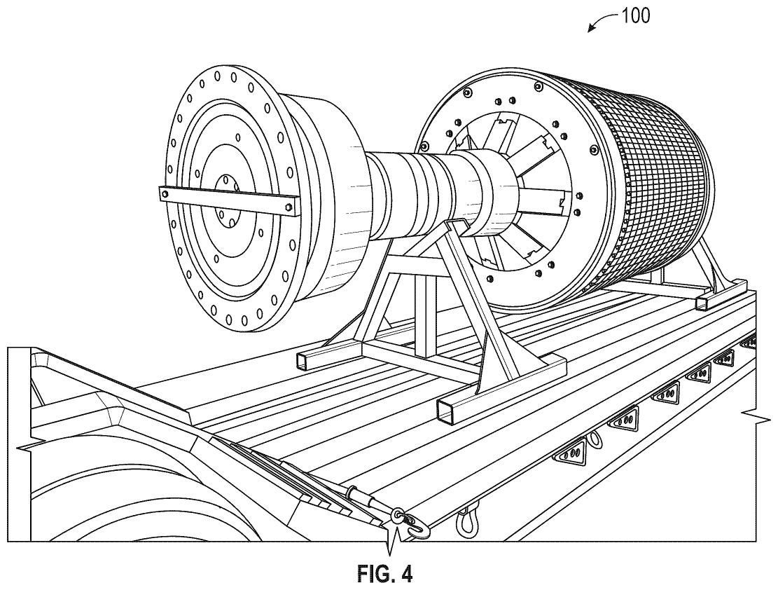

FIG. 4 illustrates the rotor 100 after removal from a generator (or electric motor) and ready for refurbishment of amortisseur bars. An example process for amortisseur bar replacement is as follows:
1. Remove rotor band
2. Machine off existing bar end connections
3. Slice existing bars into segments
4. Remove segmented existing bars
5. Clean bar holes
6. Steam clean rotor
7. Insert new segmented copper bars
8. Weld end fittings to end plates
9. Insert end segments
10. Solder end segments (e.g., silver solder)
11. Bake rotor
12. Inspect soldered connections
13. Re-clean rotor
14. Bake rotor
15. Conduct electrical tests
16. Reinstall rotor band
17. Astro spray end connections
18. Roll dip rotor
19. Bake rotor dip
20. Balance rotor
21. Paint rotor (e.g., using glyptal)

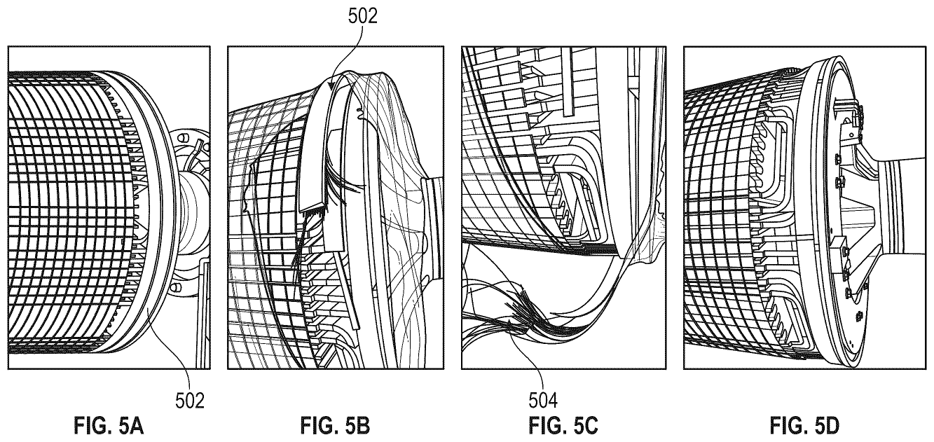

FIG. 5A illustrates an inner band 502 of the rotor 100, typically covering one more ends of the amortisseur bars. FIG. 5B illustrates the inner band 502 during the removal process to allow for replacement of certain of the bars. FIG. 5C shows a section 504 of the cover band 502 during the removal process. FIG. 5D shows the rotor 100 with the cover band 502 completely removed, now leaving extra clearance for longer amortisseur bar segments if needed.

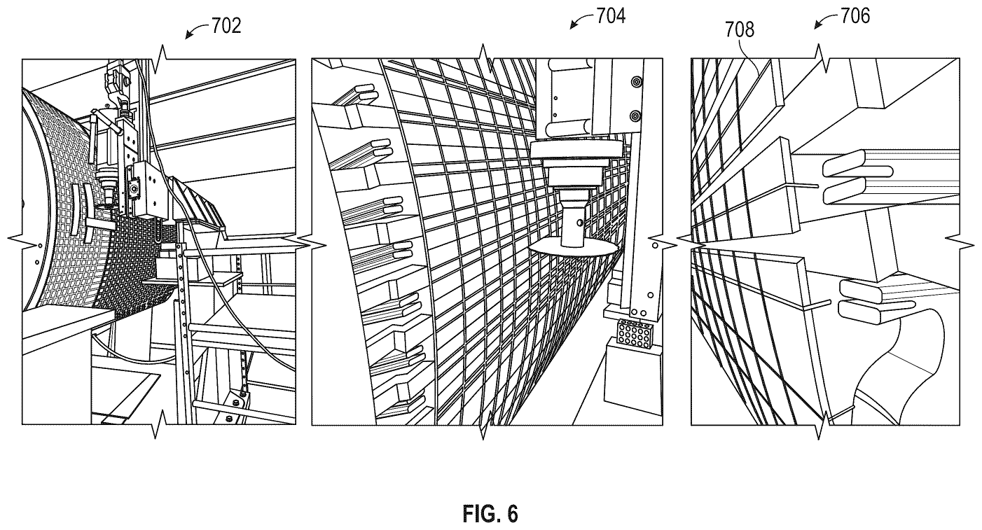

FIG. 6 illustrates a milling operation that cuts certain sections of the rotor 100. More specifically a milling operation 702 shows milling equipment disposed about the rotor 100, while milling operation 704 shows details of a milling cutter cutting a groove from one end of the rotor 100 to an opposite end of the rotor 100. Milling operation 706 then shows a resulting groove 708. The groove 708 can then used to pull out the amortisseur bars.

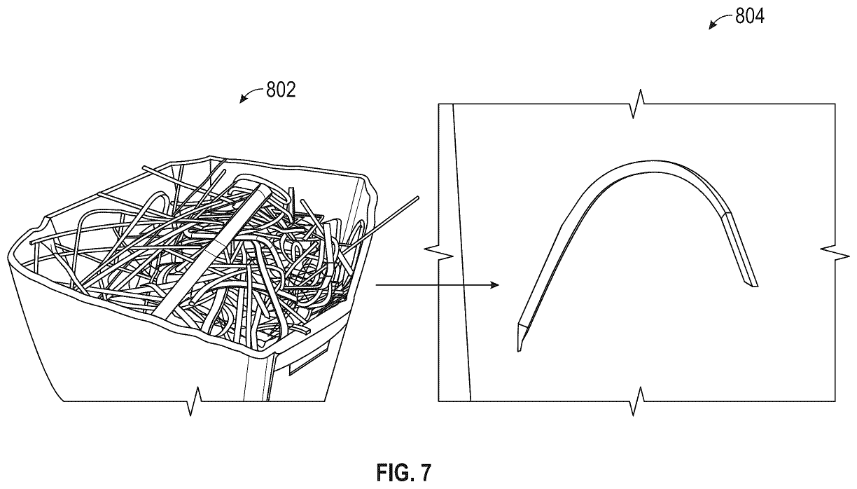

FIG. 7 shows the original amortisseur bars (after cutting and splitting in half) pulled out, for example from the groove 708 of FIG. 6, with a come along winch or other pulling device. For example, 802 shows multiple of the bars while 804 shows portions of a single bar. The pulled bars 802 will now be replaced via segmented copper bars or rods, as further described below.

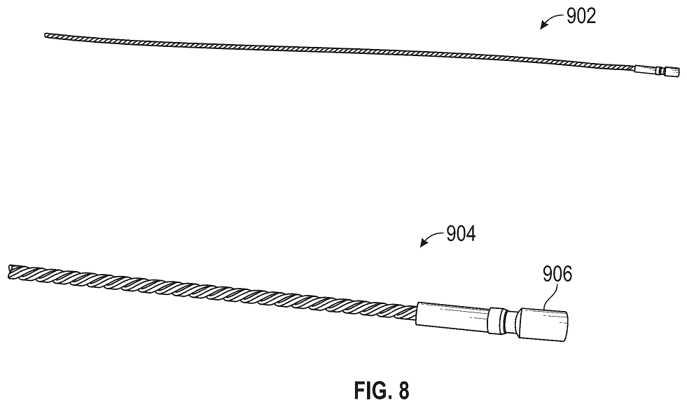

In some examples, drills are used to “clean” the openings that held the bars. FIG. 8 illustrates an abrasive bit 902 and details 904 of the abrasive bit. Bar holes are cleaned with the abrasive bits 902, 904, that can be used for cleaning the rotor locations that previously held the removed bars (e.g., bars 802). In the depicted embodiment, a drill head 906 is attached to a flexible steel shank to allow bending for clearance with windings. Once the bar locations are cleaned via the bits 902, 904, the entire rotor 100 can be cleaned.

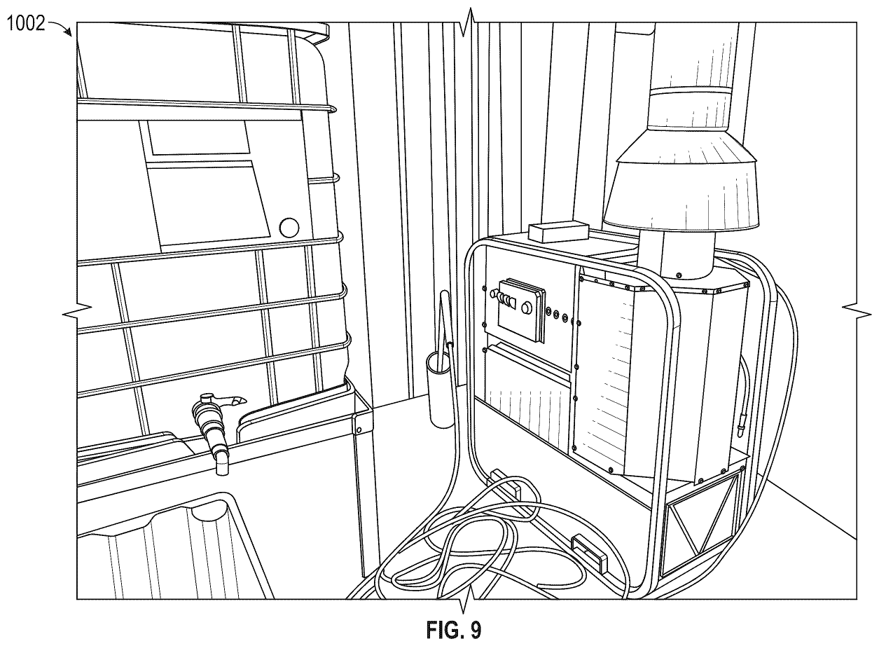

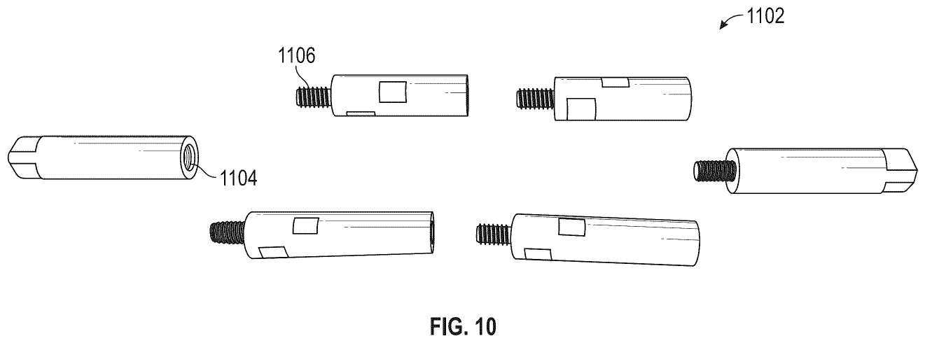

Turning now to FIG. 9, the figure shows a steam cleaning station 1002 that can be used to steam clean the rotor 100. In the depicted embodiment, steam is produced and directed towards various portions (or the entirety) of the rotor 100. The steam will then remove grease and/or particulates. The now cleaned rotor 100 is then refurbished, for example, by installing one or more copper bars, as shown in FIG. 10.

FIG. 10 illustrates a plurality of segmented bars 1102 that can used to replace an amortisseur bar. In the depicted embodiment, each bar 1102 includes a rear section 1104 having female threads manufactured to mate with male threads included in a forward section 1106. Accordingly, various lengths of bars can be accommodated by selecting a desired number of segmented bars 1102. Some property of the bars 1102 for example non-limiting purposes include:
4 Different copper bar segments-sizes can be long (80 bars), short (24 bars), left end, right end.
Long bar 2 ¾ inches (24 per bar), short bar 2 inches (33 per bar).
Double wrench flats to allow open end wrench engagement with close fit in between windings.
OD is 0.635 inches, adjusted up from 0.625 inches after first 0.625 samples were slightly. loose
Thread is ⅜-16 UNC, ½ inch in length.
Wrench flats for a 9/16 inch wrench.

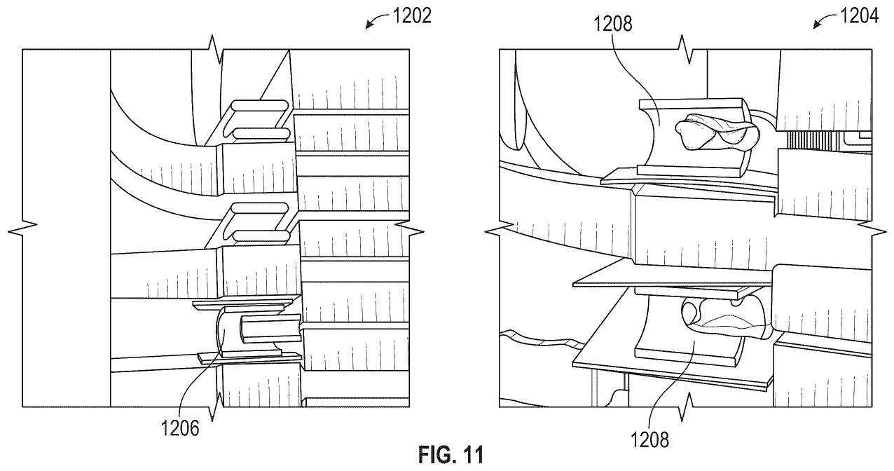

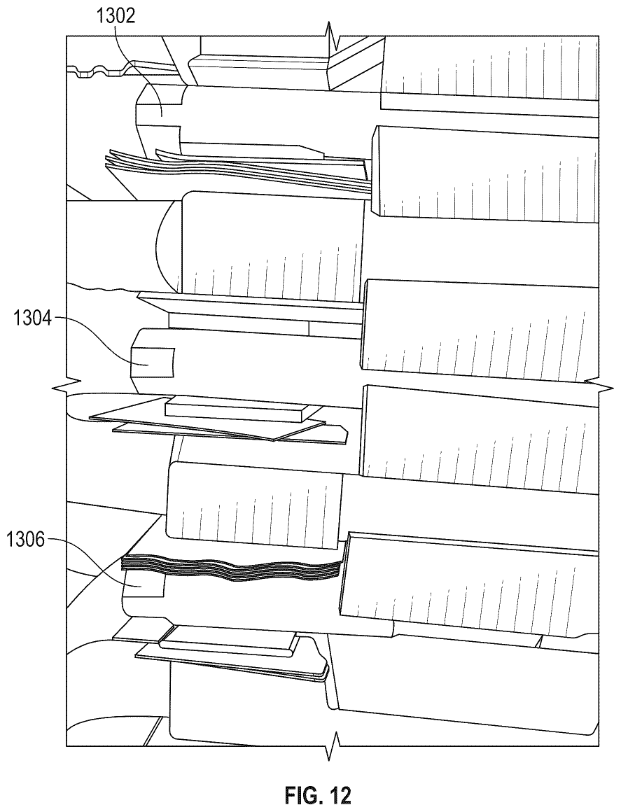

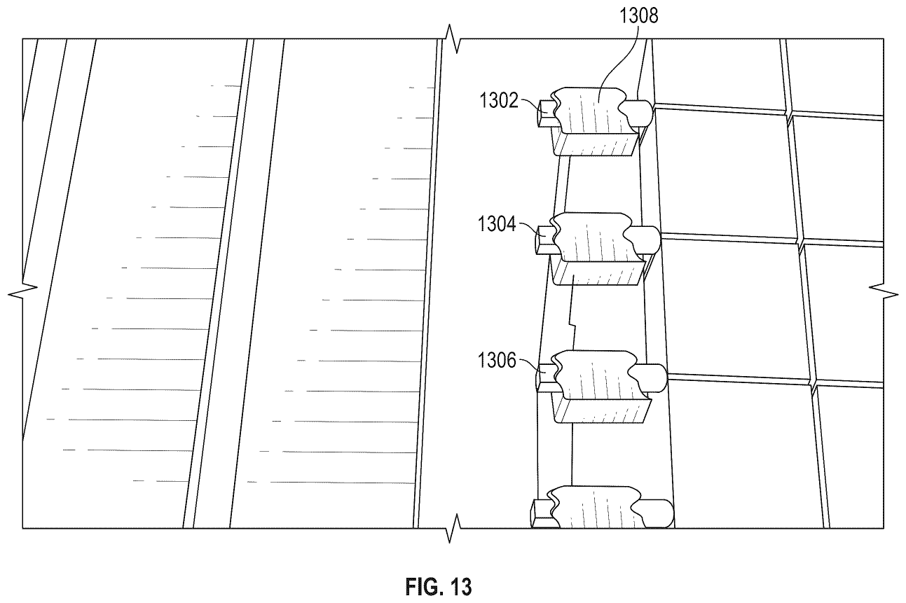

FIG. 11 illustrates metal (e.g., carbon steel) end fittings welded to end plates using sheet metal guard to protect insulation. Portion 1202 shows one welded end fitting 1206 while portion 1204 shows two welded end fittings 1208. These weld fittings can then secure end bar segments, such as bar segments 1102. For example, FIG. 12 shows three end segments 1302, 1304, and 1306 inserted into respective end fittings. Once inserted the end segments can be welded in place. For example, FIG. 13 shows the three end segments 1302, 1304, and 1306 inserted and silver soldered with solder 1308 grinded below outside diameter (OD) of the rotor 100.

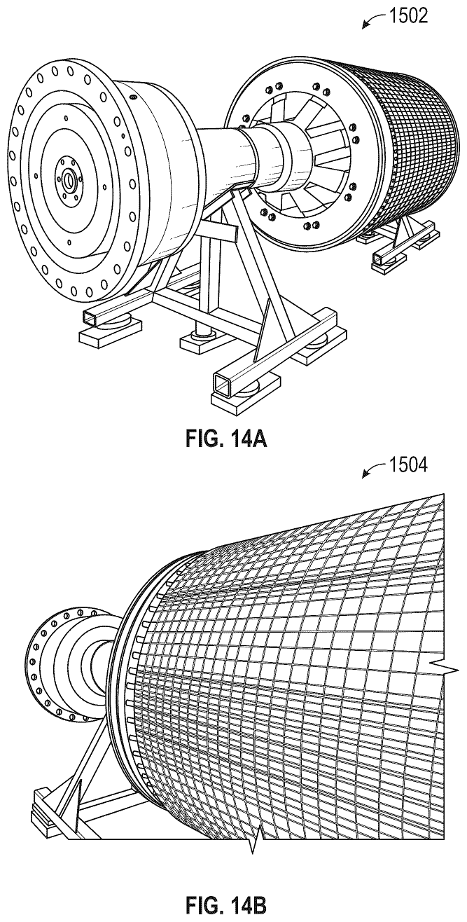

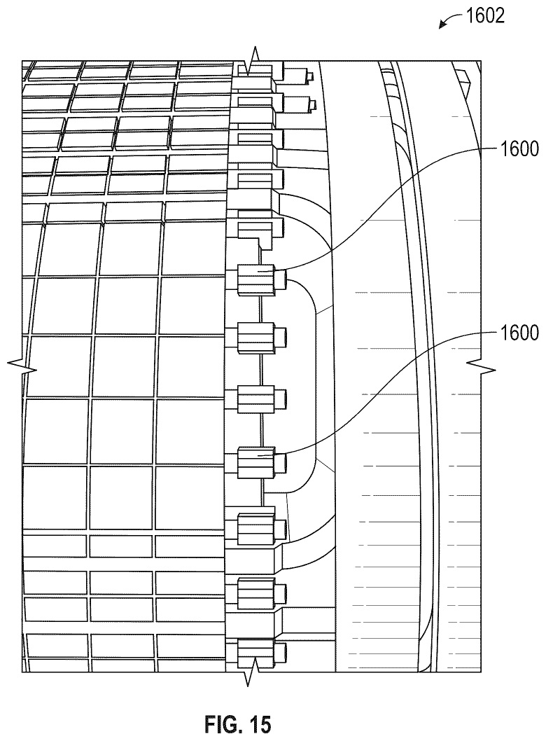

FIG. 14A is a frontal perspective view of the rotor 100 when placed inside an oven 1502. FIG. 14B shows a rear perspective view of the rotor 100 when placed inside an oven 1504. The oven is then used to bake the rotor 100, for example, at 275° F. FIG. 15 illustrates the use of dye penetrant 1600 for testing of silver solder connections for a portion 1602 of the rotor 100. The silvered soldered connections to end segments are thus inspected via the dye penetrant 1600. The rotor 100 is then steam cleaned again, and baked, for example, at 275° F. for 16 hours.

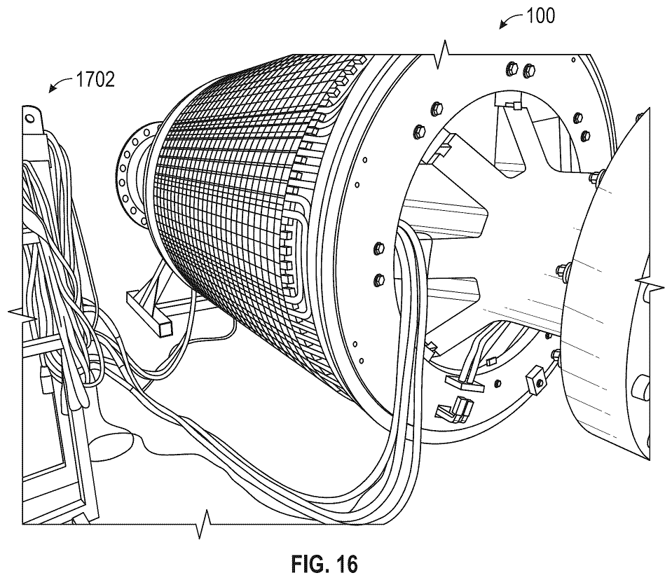

FIG. 16 shows the rotor 100 being connected to electrical test machinery 1702 for certain tests to be run, such as core loss tests, resistance tests, and the like. Indeed, after baking, the rotor 100 can then be connected to rotor test machinery to run core loss tests, resistance tests, capacitance tests, inductance tests, and so on. Should a test result in undesired results, the resulting amortisseur bar(s) can be removed and replaced as described above. Once

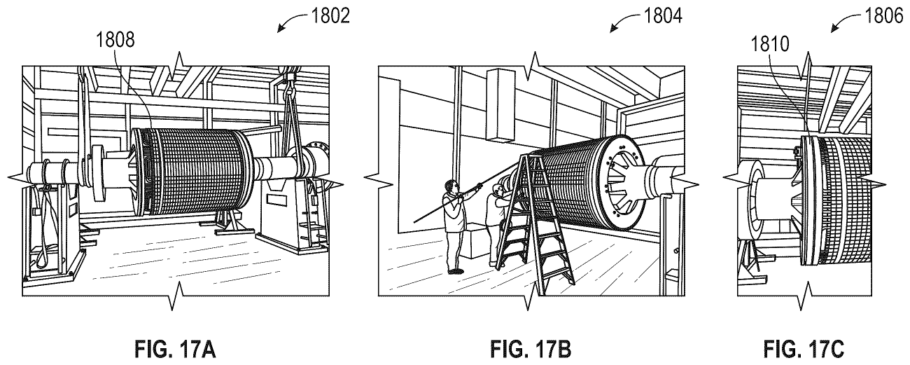

FIG. 17A-17C shows details a new band installed. That is, the inner band 502 that was cut is now replaced. More specifically, FIG. 17A illustrates a portion 1802 of the rotor 100 having a space 1808 that previously held the band 502. FIG. 17B then shows a portion 1804 of the rotor 100 having various workers installing a new band. A new band 1810 is then shown in FIG. 17C, disposed in a portion 1806 of the rotor 100.

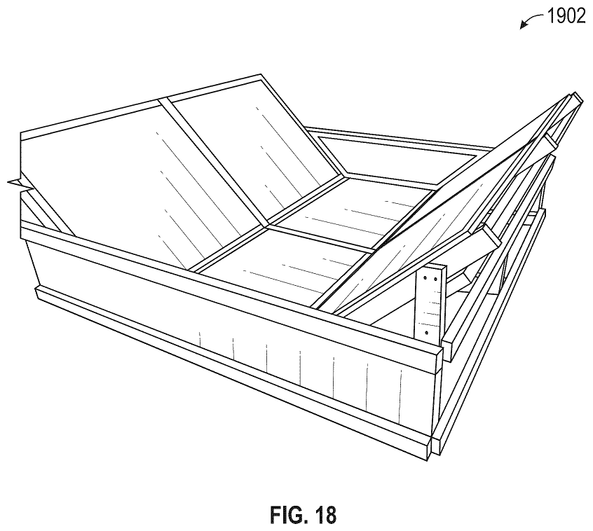

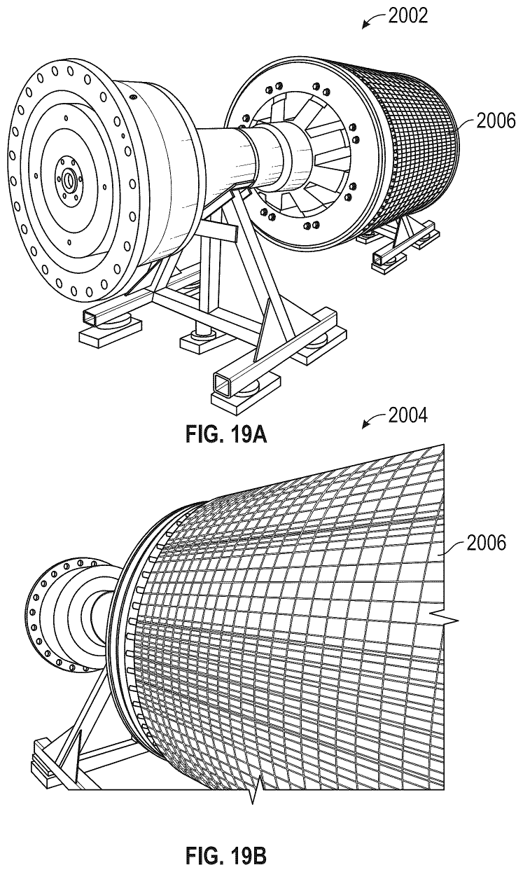

FIG. 18 illustrates a dip station 1902 used to rotor dip the rotor 100 after the new band is installed using a roll dip trough. That is, the rotor 100 can be “dipped” or immersed into liquid disposed in the dip station 1902, for example, for cleaning, for the addition of varnish, and so on. FIG. 19A illustrates a front perspective view of a roll dip varnish cure station 2002 having the rotor 100. Likewise, FIG. 19B illustrates a rear perspective view of a roll dip varnish cure station 2002 having the rotor 100. In some embodiments, the roll dip varnish cure stations are ovens that cure the varnish that was applied, for example, via the dip station 1902 of FIG. 18. That is, the varnish applied can be cured by baking.

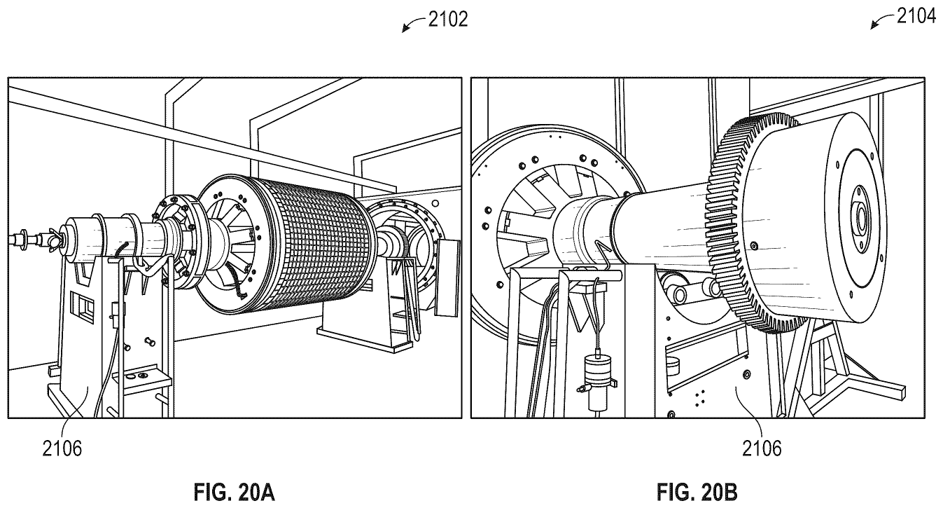

FIG. 20A illustrates a perspective view of the addition of certain weights to the rotor 100 for balancing purposes via a balancing equipment. More specifically, the rotor 100 is shown disposed in a balancing equipment 2106, which can spin the rotor 100 to determine its balance. Uneven balancing is then corrected by applying weights. FIG. 20B illustrates further details of the rotor 100 disposed in the balancing equipment 2106.

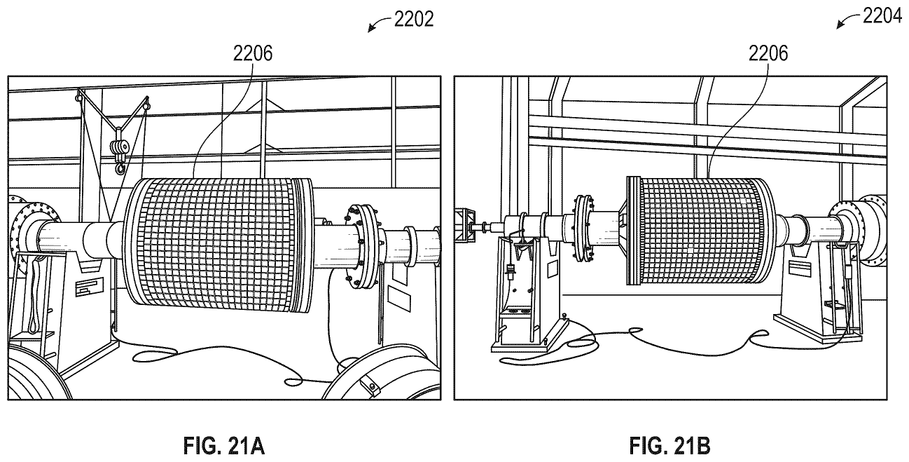

FIG. 21A illustrates a side view of the rotor 100 after the application of paint 2206, e.g., glyptal paint. Likewise, FIG. 21B illustrates another side view of the rotor 100 after the application of paint 2206. The paint 2206, such as glyptal paint, will then help protect the rotor 100 when in use. Accordingly, the rotor 100 is now refurbished and ready to be reinstalled in appropriate machinery, e.g., an electric power generator or electric motor.

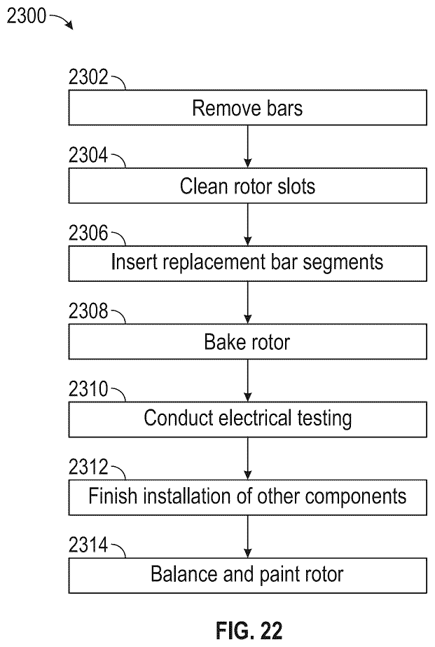

FIG. 22 is a flowchart of a process 2300 for refurbishing rotors, such as the rotor of FIG. 1A. The process 2300 includes a series of blocks for replacing amortisseur winding bars in a synchronous rotor a follows:

At block 2302, the existing bars (e.g., amortisseur bars) are removed. The block 2302 can involve segmenting the amortisseur bars within the rotor slots into removable pieces using a rotary cutting tool and extracting the segmented pieces. At block 2304, the rotor slots are then cleaned. For example, an abrasive bit attached to a flexible steel shank can be used to clean the bar holes, followed by steam cleaning of the rotor. At block 2306, replacement bar segments can then be inserted. For example, modular amortisseur bars are created and installed by inserting multiple threaded copper bar segments, such as the segments 1102. A desired bar length is achieved using various types of segments: long bars, short bars, and left/right end segments. The segments are threaded together piece-by-piece within the rotor slots. A welding of steel end fittings to end plates is then applied, securing the newly created modular amortisseur bars. Silver soldering the end segments then occurs.

The process 2300 then bakes the rotor at block 2308. In some examples, the baking involves heating the rotor to 275° F. The process 2300 then conducting electrical testing at block 2310. The electrical testing includes core loss testing, resistance testing, capacitance testing, inductance testing, and/or inspecting silver soldered electrical connections. The process 2300 then finishes installation of other components at block 2312, which can include installing the rotor band, applying astro spray to end connections, and/or performing roll dip treatment. The process 2300 then balances and paints the rotor 100 at block 2314. The balancing and painting can include adding weights as needed for proper balance, and applying protective paint coating (e.g., glyptal paint). This process enables the replacement of amortisseur winding bars without removing the main coils, resulting in a more efficient and cost-effective refurbishment process.

What is claimed is:

1. A method for refurbishing a synchronous rotor, comprising:
removing one or more amortisseur bars from rotor slots of a synchronous rotor by segmenting the one or more amortisseur bars into removable pieces;
cleaning the rotor slots after removal of the one or more amortisseur bars;
inserting a plurality of replacement modular bar segments into the cleaned rotor slots, wherein the replacement modular bar segments comprise threaded metal segments configured to be assembled piece-by-piece within the rotor slots;
baking the synchronous rotor after insertion of the replacement modular bar segments;
conducting electrical testing of the synchronous rotor after baking;
finishing installation by installing additional rotor components; and
balancing and painting the synchronous rotor, wherein the synchronous rotor comprises the one or more amortisseur bars disposed within the rotor slots of the synchronous rotor.

2. The method of claim 1, wherein the plurality of replacement modular bar segments each comprises a first end having male threads.

3. The method of claim 2, the plurality of replacement modular bar segments each comprises a second end having female threads, and wherein the male threads are configured to be threaded into the female threads.

4. The method of claim 3, wherein the plurality of replacement modular bar segments each comprises a metal bar segment.

5. The method of claim 4, wherein the metal bar segment comprises a copper bar segment.

6. The method of claim 1, wherein segmenting the one or more amortisseur bars into removable pieces comprises milling the rotor slots having the one or more amortisseur bars via a milling machine.

7. The method of claim 6, further comprising removing the removable pieces after milling.

8. The method of claim 7, wherein removing the removable pieces comprises pulling the removable pieces through a groove milled via the milling.

9. The method of claim 8, comprising using a winch to pull the removable pieces.

10. The method of claim 1, comprising selecting the plurality of replacement modular bar segments based on a length of the one or more amortisseur bars before inserting the plurality of replacement modular bar segments.

11. The method of claim 10, wherein at least one of the plurality of replacement modular bar segments comprises a short length, a medium length, or a long length.

12. A refurbished synchronous rotor produced by a process comprising:
removing one or more amortisseur bars from rotor slots of a synchronous rotor by segmenting the one or more amortisseur bars into removable pieces;
cleaning the rotor slots after removal of the one or more amortisseur bars;
inserting a plurality of replacement modular bar segments into the cleaned rotor slots, wherein the replacement modular bar segments comprise threaded metal segments configured to be assembled piece-by-piece within the rotor slots;
baking the synchronous rotor after insertion of the replacement modular bar segments;
conducting electrical testing of the synchronous rotor after baking;
finishing installation by installing additional rotor components; and
balancing and painting the synchronous rotor, wherein the refurbished synchronous rotor comprises the replacement modular bar segments disposed within the rotor slots in place of the removed amortisseur bars.

13. The refurbished synchronous rotor of claim 12, wherein the plurality of replacement modular bar segments each comprises a first end having male threads.

14. The refurbished synchronous rotor of claim 13, the plurality of replacement modular bar segments each comprises a second end having female threads, and wherein the male threads are configured to be threaded into the female threads.

15. The refurbished synchronous rotor of claim 14, wherein the plurality of replacement modular bar segments each comprises a metal bar segment.

16. A method for replacing amortisseur winding bars in a synchronous rotor, said rotor comprising main coils and amortisseur bars disposed within rotor slots, the method comprising:
segmenting the amortisseur bars within the rotor slots into removable pieces using a rotary cutting tool;
extracting the segmented amortisseur bar pieces from the rotor slots;
cleaning the rotor slots;
assembling replacement modular amortisseur bars within the cleaned rotor slots by inserting a plurality of short, threaded copper bar segments piece-by-piece into the rotor slots, said short bar segments being shaped and sized to fit between the main coils and a rotor core;
inserting copper end bar segments into openings at ends of the rotor slots;
welding steel end fittings to rotor core end plates;
silver soldering the copper end bar segments to the steel end fittings;
baking the rotor
inspecting soldered connections
re-cleaning the rotor;
re-baking the rotor;
conducting electrical tests on the rotor;
installing a rotor band on the rotor;
spraying end connections of the rotor;
roll dipping the rotor;
re-baking the rotor;
balancing the rotor; and
paint rotor, wherein thereby replacing the amortisseur winding bars is performed without removing the main coils.
